(19) United States
(12) Patent Application Publication
(10) Pub. No.: US 2026/0064100 A1
(43) Pub. Date: Mar. 5, 2026

(54) METHOD OF FINDING MINIMUM REPEAT UNIT IN LAYOUT AND METHOD OF MANUFACTURING INTEGRATED CIRCUIT DEVICE USING THE METHOD

(71) Applicant: Samsung Electronics Co., Ltd., Suwon-si (KR)

(72) Inventors: Hoduk Cho, Suwon-si (KR); Gukhyun Kim, Suwon-si (KR); Pilsoo Kang, Suwon-si (KR); Heungsuk Oh, Suwon-si (KR)

(21) Appl. No.: 19/177,707

(22) Filed: Apr. 14, 2025

(30) Foreign Application Priority Data
Aug. 28, 2024 (KR) 10-2024-0116004

(51) Int. Cl. G05B 19/4097

(52) U.S. Cl. CPC G05B 19/4097

(57) ABSTRACT

A method of manufacturing an integrated circuit device using a layout, the layout including patterns having edges, includes determining whether periodicity exists in a search region of the layout from values of a first shortest separation distance in a first direction and values of a second shortest separation distance in a second direction between edges, based on hash codes obtained from length information and direction information about edges in the search region and distance information between the edges, wherein the second direction is perpendicular to the first direction. When it is determined that the layout has periodicity in the search region, a unit region that has a smallest width corresponding to a first least common multiple of values of the first shortest separation distance and a smallest height corresponding to a second least common multiple of values of the second shortest separation distance is determined as a minimum repeat unit.

### CROSS-REFERENCE TO RELATED APPLICATION

This application is based on and claims priority under 35 U.S.C. § 119 to Korean Patent Application No. 10-2024-0116004, filed on Aug. 28, 2024, in the Korean Intellectual Property Office, the disclosure of which is incorporated by reference herein in its entirety.

### BACKGROUND

The inventive concept relates to an integrated circuit (IC) device, and more particularly, to a method of finding a minimum repeat unit of a layout for manufacturing an IC device and a method of manufacturing an IC device by using the method.

As semiconductor devices become more miniaturized, the integration density of semiconductor designs may increase, and geometric structures of semiconductor processes may become more refined. Accordingly, before a layout designed for the manufacture of IC devices is actually applied to processes and products are mass-produced, various simulations and verifications may be performed on a repeat unit of a predetermined size, which is a portion of the layout, and thus defects that may occur in the IC device may be reduced. Up to now, to perform simulations and verifications required for subsequent processes on the designed layout, a user has directly determined a minimum repeat unit in the layout. As a result, there is a problem that productivity is reduced because it takes much time for the user to determine the minimum repeat unit and there are limitations in tasks, such as the reconstruction of hierarchies, due to the limitation that the minimum repeat unit is manually determined by the user.

### SUMMARY

Aspects of the inventive concept provide a method of finding a minimum repeat unit of a layout, by which minimum repeat unit information may be automatically found from a layout designed to manufacture an integrated circuit (IC) device so that time and cost for determining minimum repeat unit information about the layout may be reduced.

Aspects of the inventive concept also provide a method of manufacturing an IC device, by which simulations and verifications may be accurately and efficiently performed on a layout, which is designed to manufacture an IC device, by using minimum repeat unit information automatically found from the layout.

According to an aspect of the inventive concept, a method of manufacturing an integrated circuit device using a layout, wherein the layout includes patterns having edges, includes determining, using a processor, whether periodicity exists in a search region of the layout from values of a first shortest separation distance in a first lateral direction and values of a second shortest separation distance in a second lateral direction between the edges, based on hash codes obtained from length information and direction information about each of the edges in the search region and distance information between the edges, wherein the search region is a selected partial region of the layout centered on a gauge line in the layout, and the second lateral direction is perpendicular to the first lateral direction; determining, using the processor, a minimum repeat unit of the layout, wherein the determining of the minimum repeat unit comprises determining, as the minimum repeat unit, a unit region of the layout centered on the gauge line and having a smallest width corresponding to a first least common multiple of the values of the first shortest separation distance and a smallest height corresponding to a second least common multiple of the values of the second shortest separation distance; and forming a corrected layout by performing, using the processor, a correction process on the layout based on the determined minimum repeat unit of the layout; and forming the integrated circuit device using the corrected layout.

According to another aspect of the inventive concept, a method of manufacturing an integrated circuit device using a layout, wherein the layout includes patterns having edges, includes determining, using a processor, a condition of the patterns in a search region of the layout as one of a first condition, a second condition, and a third condition, wherein in the first condition, the patterns in the search region are first line-and-space patterns extending in any one of a first lateral direction and a second lateral direction, wherein in the second condition, the patterns in the search region are second line-and-space patterns extending in a third lateral direction, and wherein in the third condition, the patterns in the search region are a plurality of island patterns; generating, using the processor, hash codes for length information and direction information about each of the edges, hash codes for length information and direction information about each of neighbor edges included in a neighbor region of each of the edges, and hash codes for distance information between the edges; determining, using the processor, whether periodicity of the layout exists in the search region from values of a first shortest separation distance in the first lateral direction and values of a second shortest separation distance in the second lateral direction between the edges, based on the hash codes, wherein the search region is a selected partial region centered on a gauge line in the layout, the second lateral direction is perpendicular to the first lateral direction, and the third lateral direction is oblique with respect to each of the first lateral direction and the second lateral direction; determining, using the processor, the minimum repeat unit of the layout, wherein the determining of the minimum repeat unit comprises determining, as the minimum repeat unit, a unit region of the layout centered on the gauge line and having a smallest width corresponding to a first least common multiple of the values of the first shortest separation distance and a smallest height corresponding to a second least common multiple of the values of the second shortest separation distance; and forming a corrected layout by performing, using the processor, a correction process on the layout based on the determined minimum repeat unit of the layout; and forming the integrated circuit device using the corrected layout.

According to another aspect of the inventive concept, a method of manufacturing an integrated circuit device includes designing, using a processor, a layout, the layout comprising patterns having edges; automatically finding, using the processor, a first minimum repeat unit in the layout; and simulating, using the processor, the layout by using the first minimum repeat unit, wherein the automatically finding of the first minimum repeat unit in the layout comprises: determining whether periodicity exists in a search region of the layout from values of a first shortest separation distance in a first lateral direction and values of a second shortest separation distance in a second lateral direction between the edges, based on hash codes for length information and direction information about each of the edges in a search region and distance information between the edges, wherein the search region is a selected partial region of the layout centered on a gauge line in the layout, and the second lateral direction is perpendicular to the first lateral direction; and determining, as the minimum repeat unit of the layout, a unit region of the layout centered on the gauge line and having a smallest width corresponding to a first least common multiple of the values of the first shortest separation distance and a smallest height corresponding to a second least common multiple of the values of the second shortest separation distance.

### BRIEF DESCRIPTION OF THE DRAWINGS

Embodiments will be more clearly understood from the following detailed description taken in conjunction with the accompanying drawings in which:

FIG. 1 is a flowchart of a method of finding a minimum repeat unit of a layout, according to embodiments;

FIGS. 2A and 2B are flowcharts for further specifically explaining the method of finding a minimum repeat unit in the layout, which is described with reference to FIGS. 1 and 3A to 8;

FIGS. 3A, 3B, and 3C are each a layout diagram for explaining a method of finding a minimum repeat unit of a layout, according to embodiments;

FIGS. 4A, 4B, and 4C are each a layout diagram for explaining a method of finding a minimum repeat unit of a layout, according to embodiments;

FIGS. 5A, 5B, and 5C are each a layout diagram for explaining a method of finding a minimum repeat unit of a layout, according to embodiments;

FIGS. 6A, 6B, and 6C are each a layout diagram for explaining a method of finding a minimum repeat unit of a layout, according to embodiments;

FIGS. 7A, 7B, and 7C are each a layout diagram for explaining a method of finding a minimum repeat unit of a layout, according to embodiments;

FIG. 8 is a table showing examples of hash codes that may be generated in a method of finding a minimum repeat unit of a layout, according to embodiments;

FIG. 9 is a diagram for explaining a plurality of linear components that constitute each of edges included in an island pattern in a search region according to a method of finding a minimum repeat unit of a layout, according to embodiments; and

FIG. 10 is a flowchart of a method of manufacturing an integrated circuit (IC) device, according to embodiments.

### DETAILED DESCRIPTION OF THE EMBODIMENTS

Hereinafter, embodiments will be described in detail with reference to the accompanying drawings. The same reference numerals are used to denote the same elements in the drawings, and repeated descriptions thereof will be omitted.

An item, layer, or portion of an item or layer described as extending “extending” or as extending “lengthwise” in a particular direction has a length in the particular direction and a width perpendicular to that direction, where the length is greater than the width.

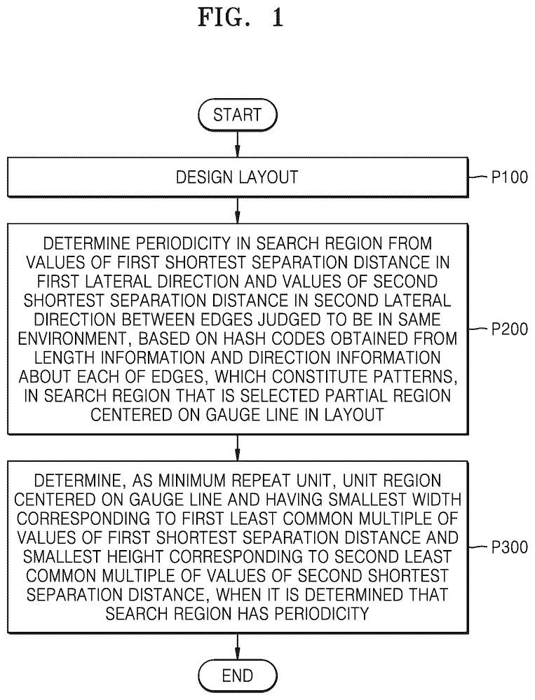

FIG. 1 is a flowchart of a method of finding a minimum repeat unit of a layout, according to embodiments.

The methods set forth in the disclosure may be performed, e.g., by one or more processors included in a computer. The computer (or several interconnected computers) may include, for example, one or more processors configured by software, such as a CPU (Central Processing Unit), GPU (graphics processor), controller, etc., forming various functional modules of the computer. The computer may be a general purpose computer or may be dedicated hardware or firmware (e.g., an electronic or optical circuit, such as application-specific hardware, such as, for example, a digital signal processor (DSP) or a field-programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of the control unit may each correspond to a separate segment or segments of software (e.g., a subroutine) which configure the computer, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script, that may be stored in a storage. The storage may comprise conventional memory of a computer, such as a hard drive (which may be a solid state drive, DRAM, NAND flash memory, etc.). The computer may comprise a conventional computer user interface and include convention input devices, such as a keyboard, mouse, trackpad, touchscreen, etc.

Referring to FIG. 1, in process P100, layout design may be performed. In embodiments, the layout design may be performed in a layout design tool. The layout design according to process P100 may be performed based on a design rule. The design rule may define a plurality of rules that are based on a process of manufacturing an integrated circuit (IC) device. For example, the design rule may define a pitch of patterns and a space between patterns, which are allowed in the same conductive layer. A layout of an IC device may be designed to comply with a plurality of rules defined in the design rule.

The layout designed in process P100 may be provided in a standardized digital file, such as a graphic design system (GDS) or an open artwork system interchange standard (OASIS), but layout data is not limited to the above-described file format.

In process P200 of FIG. 1, the periodicity of the layout may be determined in a search region, which is a selected partial region centered on a gauge line randomly located on the layout designed in process P100.

To determine the periodicity of the layout, hash codes may be generated from length information and direction information about each of edges extending in an arbitrary direction in the search region and distance information between the edges. In addition, based on the hash codes, periodicity in the search region may be determined from values of a first shortest separation distance in a first lateral direction and values of a second shortest separation distance in a second lateral direction between edges judged to be in the same environment. The second lateral direction may be perpendicular to the first lateral direction.

As used herein, the hash codes may refer to a string of bits obtained from the output of a hash function. The hash function may be a function that maps data of an arbitrary length to data of a fixed length. As used herein, a value obtained by the hash function may be referred to as a hash code or hash.

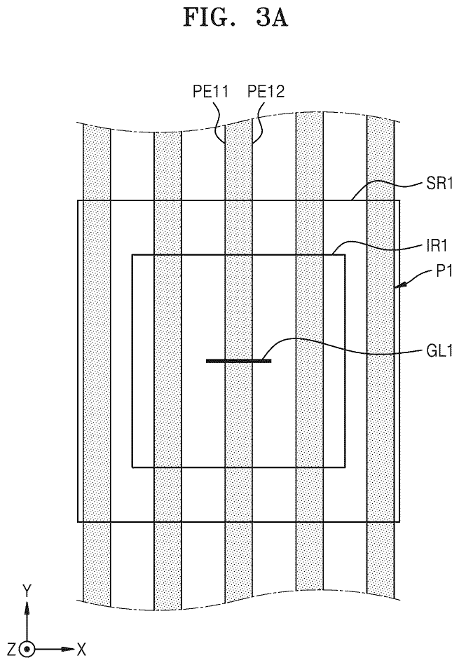

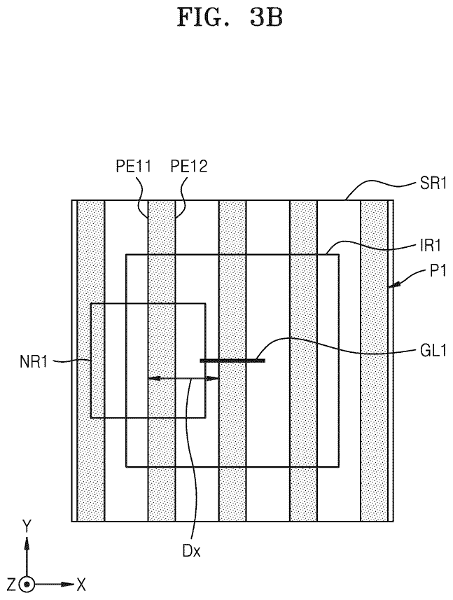

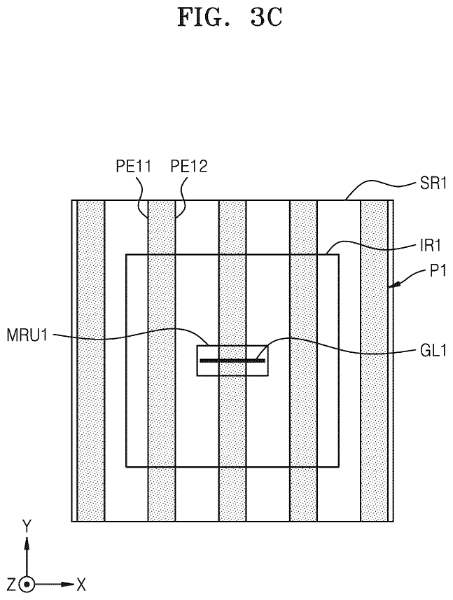

FIGS. 3A, 4A, 5A, 6A, and 7A illustrate layouts of various shapes including patterns of various shapes. FIGS. 3A, 4A, 5A, 6A, and 7A respectively illustrate search regions SR1, SR2, SR3, SR4, and SR5, each of which is a partial region selected from a layout corresponding thereto, and interest regions IR1, IR2, IR3, IR4, and IR5, which are partial regions of the search regions SR1, SR2, SR3, SR4, and SR5, respectively. The search regions SR1, SR2, SR3, SR4, and SR5 and the interest regions IR1, IR2, IR3, IR4, and IR5 may each be defined as a rectangular region. For example, an interest region may be a region of the layout that will be analyzed by a user to determine if it is composed of repeating unit cells, and may be set by the user.

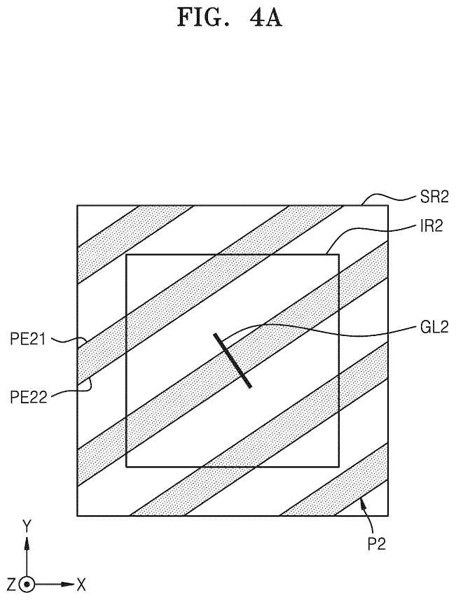

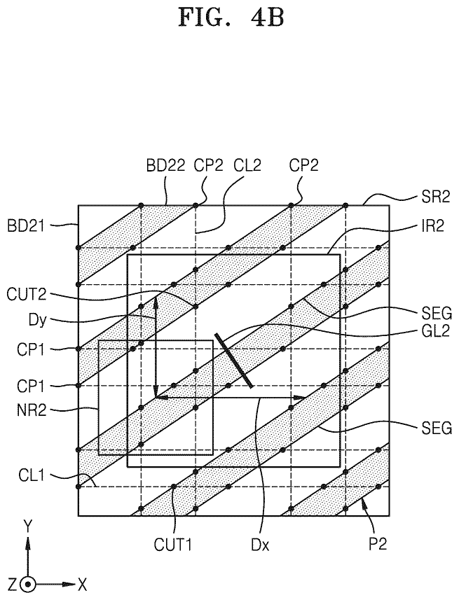

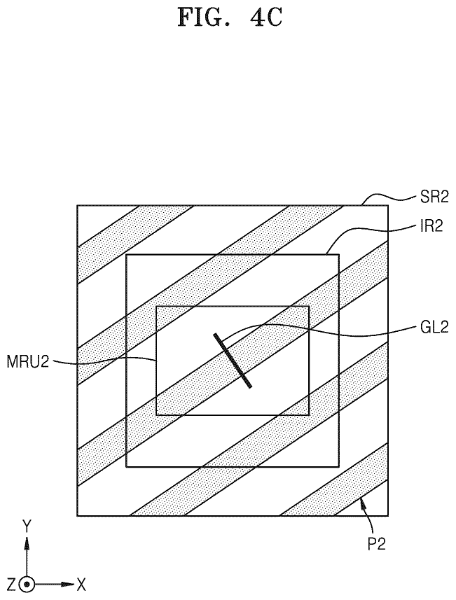

For brevity, FIGS. 4A, 5A, 6A, and 7A respectively illustrate only portions of layouts, which are included in the search regions SR2, SR3, SR4, and SR5, and the illustration of portions of the layouts, which are not included in the search regions SR2, SR3, SR4, and SR5, is omitted.

For example, as shown in FIG. 3A, in a layout including line-and-space (L/S) patterns P1, which are apart from each other in a first lateral direction (X direction) and extend lengthwise in a second lateral direction (Y direction) that is perpendicular to the first lateral direction (X direction), to determine the periodicity of the layout in the search region SR1, which is a selected partial region centered on a gauge line GL1, hash codes may be generated from length information and direction information about each of a plurality of edges PE11 and PE12 extending lengthwise in the second lateral direction (Y direction) in the search region SR1 and distance information between the plurality of edges PE11 and PE12. The gauge line GL1 may be a position where a critical dimension of one or more features of interest of the layout may be measured.

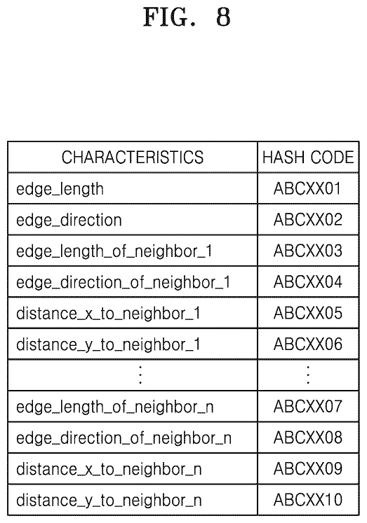

FIG. 8 is a table showing examples of hash codes that may be generated from the L/S patterns P1 shown in FIG. 3A.

In FIG. 8, “edge_length” may refer to a length of any one of a plurality of edges PE11 and PE12 shown in FIG. 3A, “edge_direction” may refer to a direction of any one of the plurality of edges PE11 and PE12 shown in FIG. 3A, “edge_length_of_neighbor_1” may refer to a length of a neighbor edge adjacent to any one of the plurality of edges PE11 and PE12, “edge_direction_of_neighbor_1” may refer to a direction of a neighbor edge adjacent to any one of the plurality of edges PE11 and PE12, “distance_x_to_neighbor_1” may refer to a distance in a first lateral direction (X direction) between any one of the plurality of edges PE11 and PE12 and a neighbor edge adjacent thereto, and “distance_y_to_neighbor_1” may refer to a distance in a second lateral direction (Y direction) between any one of the plurality of edges PE11 and PE12 and a neighbor edge adjacent thereto.

In process P200 of FIG. 1, as shown in FIG. 8, various hash codes that are considered necessary for finding a minimum repeat unit of a layout, such as hash codes for length information and direction information about each of the plurality of edges PE11 and PE12 and hash codes for distance information between each of the plurality of edges PE11 and PE12 and a plurality of neighbor edges (e.g., n neighbor edges (here, n is an arbitrary natural number) adjacent thereto in the first lateral direction (X direction) and the second lateral direction (Y direction)), may be generated.

In process P200 of FIG. 1, after the hash codes are generated, as shown in FIG. 3B, periodicity in the search region SR1 may be determined from values of a first shortest separation distance Dx in the first lateral direction (X direction) between edges judged to be in the same environment, based on the hash codes.

In a layout including L/S patterns P2 that extend lengthwise in an oblique direction (inclusively referred to as a third lateral direction) with respect to each of the first lateral direction (X direction) and the second lateral direction (Y direction) as shown in FIG. 4A, periodicity in the search region SR2 may be determined from the values of the first shortest separation distance Dx in the first lateral direction (X direction) and values of a second shortest separation distance Dy in the second lateral direction (Y direction) between edges judged to be in the same environment, based on hash codes generated for the L/S patterns P2 as shown in FIG. 4B.

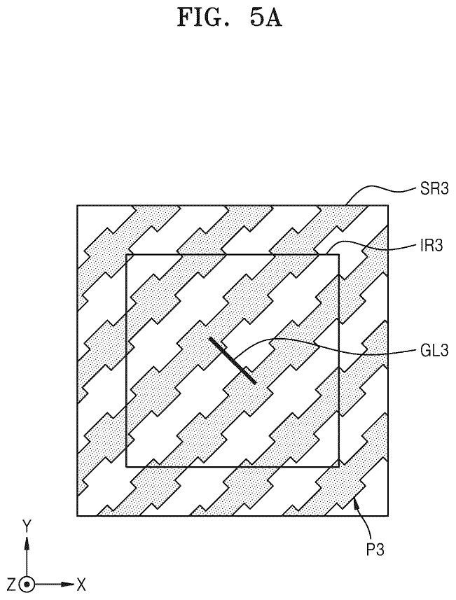

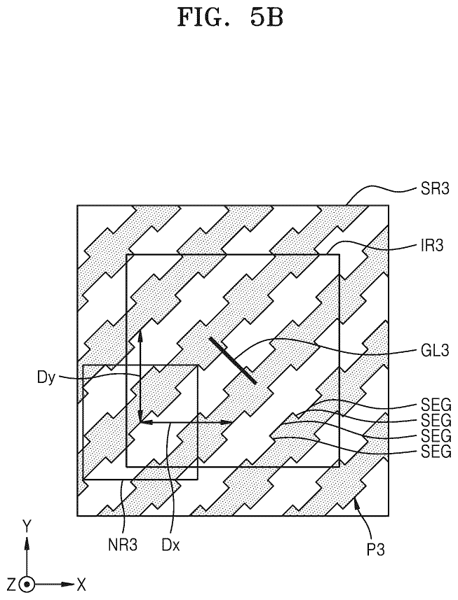

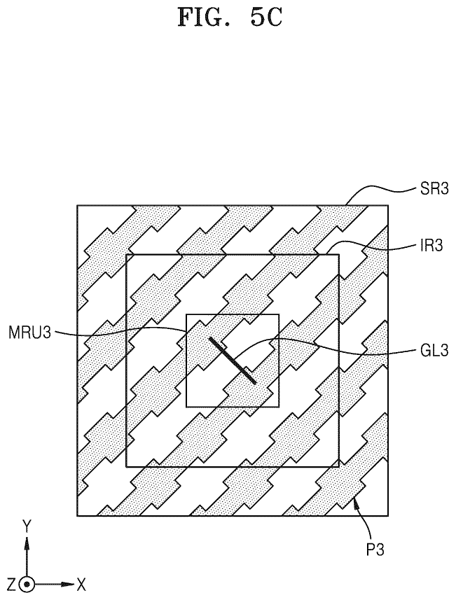

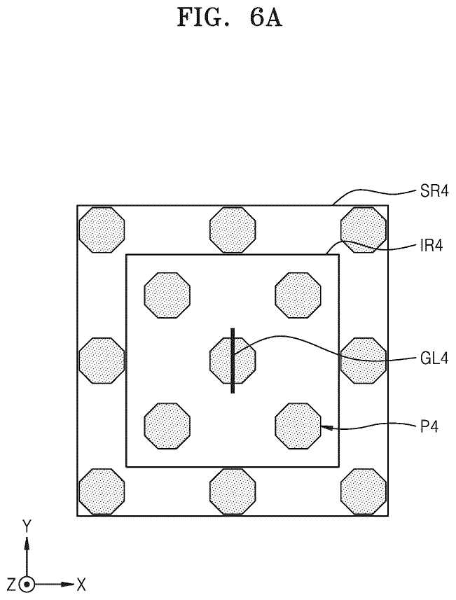

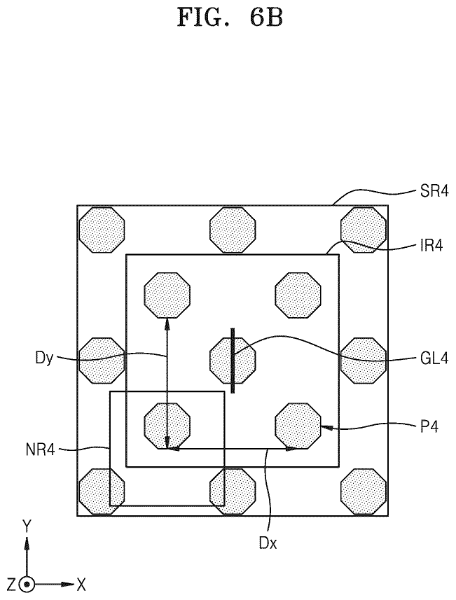

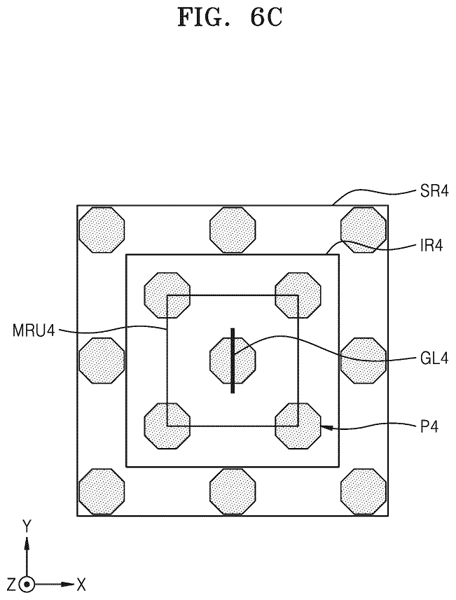

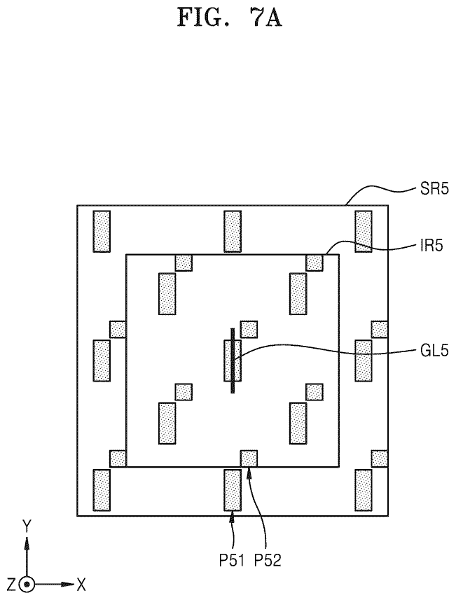

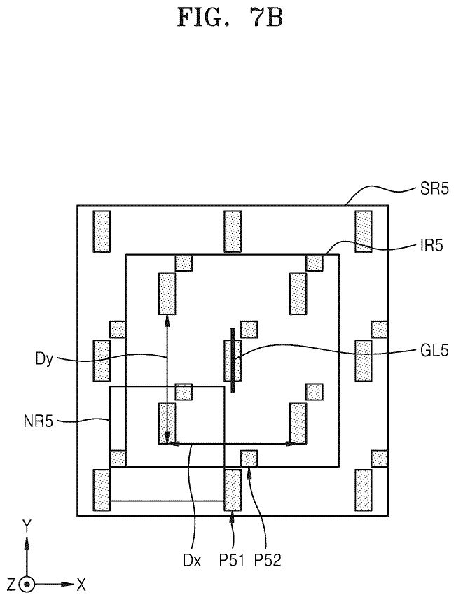

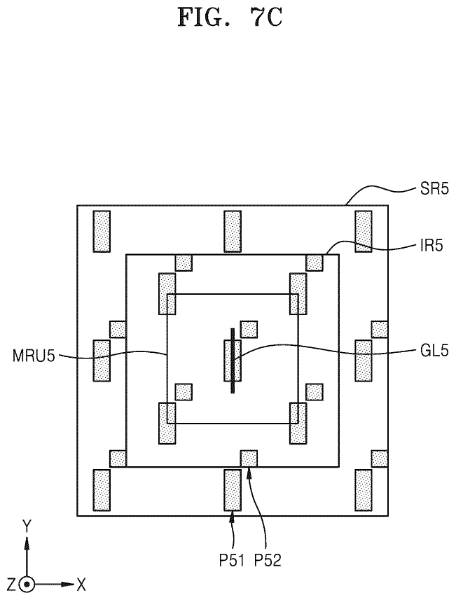

In a layout including L/S patterns P3 on which optical proximity correction (OPC) has been performed as shown in FIG. 5A, a layout including a plurality of island patterns P4 as shown in FIG. 6A, and a layout where a plurality of island patterns P51 and P52 of different shapes are mixed as shown in FIG. 7A, similarly to the above description, periodicity in the search region SR3, SR4, and SR5 may be determined from values of a first shortest separation distance Dx in the first lateral direction (X direction) and values of a second shortest separation distance Dy in the second lateral direction (Y direction) between edges judged to be in the same environment, based on hash codes generated for the pattern corresponding thereto.

In process P300 of FIG. 1, when it is determined in process P200 that the layout has periodicity in the search regions SR1, SR2, SR3, SR4, and SR5, a unit region, which is centered on the gauge line GL1, GL2, GL3, GL4, or GL5 and has a smallest width corresponding to a first least common multiple of the values of the first shortest separation distance Dx and a smallest height corresponding to a second least common multiple of the values of the second shortest separation distance Dy, may be determined as a minimum repeat unit. As used herein, the minimum repeat unit may refer to a minimum unit that is repeated in a plurality of patterns included in a layout.

In process P300 of FIG. 1, when the values of the first shortest separation distance Dx are all the same, the first least common multiple may be equal to the values of the first shortest separation distance Dx. Also, when the values of the second shortest separation distance Dy are all the same, the second least common multiple may be equal to the values of the second shortest separation distance Dy.

For example, in the layout including the L/S patterns P1 shown in FIGS. 3A to 3C, a unit region, which is centered on the gauge line GL1 and has a smallest width corresponding to the first least common multiple of the values of the first shortest separation distance Dx in the first lateral direction (X direction), may be determined as a minimum repeat unit MRU1.

In each of the layout including the L/S patterns P2 as shown in FIGS. 4A to 4C, the layout including the L/S patterns P3 on which OPC has been performed as shown in FIGS. 5A to 5C, the layout including the plurality of island patterns P4 as shown in FIGS. 6A to 6C, and the layout where the plurality of island patterns P51 and P52 of different shapes are mixed as shown in FIGS. 7A to 7C, unit regions, which are respectively centered on the gauge lines GL2, GL3, GL4, and GL5 and have the smallest width corresponding to the first least common multiple of the values of the first shortest separation distance Dx in the first lateral direction (X direction) and the smallest height corresponding to the second least common multiple of the values of the second shortest separation distance Dy in the second lateral direction (Y direction), may be respectively determined as minimum repeat units MRU2, MRU3, MRU4, and MRU5.

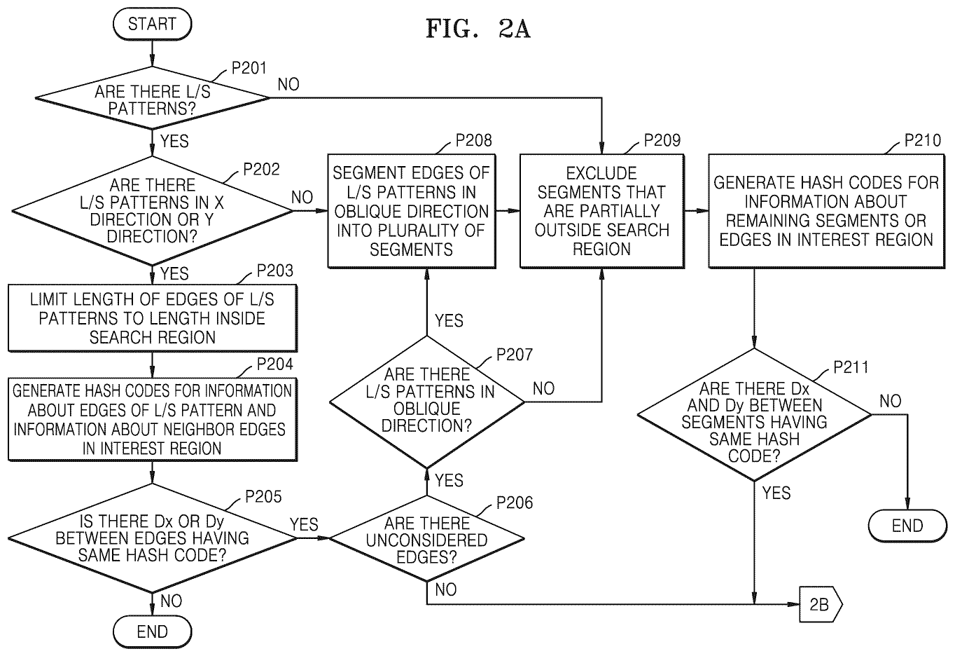

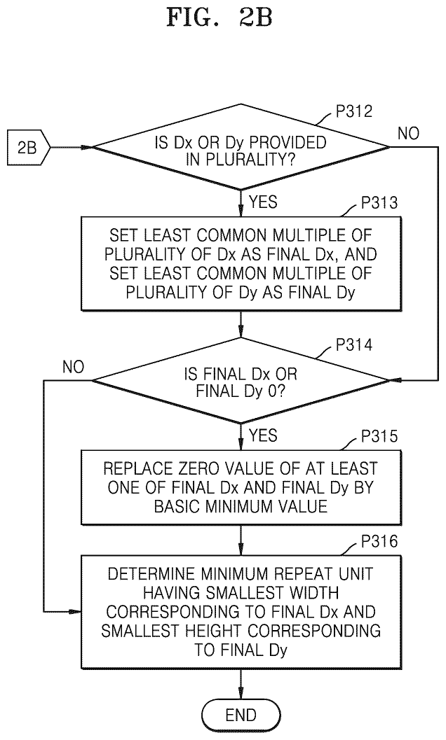

FIGS. 2A and 2B are flowcharts for further specifically explaining a method of finding the minimum repeat unit in the layout, which is described with reference to FIGS. 1 and 3A to 7C. FIG. 2A illustrates detailed processes for determining periodicity of the layout in a search region, which is a partial region of the layout, according to process P200 of FIG. 1. FIG. 2B illustrates detailed processes for determining a minimum repeat unit in the search region, according to process P300 of FIG. 1. The search region may be determined by an interest region and a neighbor region set by a user, and may have a width and height equal t other respective sum of widths and heights of the interest region and the neighbor region.

In process P201 of FIG. 2A, it may be determined whether there are L/S patterns in the search region of the layout designed in process P100 of FIG. 1.

For example, as shown in FIGS. 3A and 4B, when a plurality of edges included in patterns that constitute the layout continuously extend through the search regions SR1 and SR2 to intersect boundaries defining the search regions SR1 and SR2 at at least one point, it may be determined that L/S patterns exist in the search regions SR1 and SR2 of the layout.

When it is determined in process P201 that the L/S patterns do not exist in the search region, the method may proceed to process P209. When it is determined in process P201 that L/S patterns exist in the search region, the method may proceed to process P202.

In process P202, it may be determined whether the L/S patterns are L/S patterns (inclusively referred to as first L/S patterns) extending lengthwise in a first lateral direction (X direction) or a second lateral direction (Y direction) in the search region of the layout. In embodiments, in process P202, when the layout includes edges (inclusively referred to as first edges) that pass through the search region and extend in at least one of the first lateral direction (X direction) and the second lateral direction (Y direction), it may be determined that the layout includes the L/S patterns extending lengthwise in the first lateral direction (X direction) or the second lateral direction (Y direction).

In embodiments, based on an angle of an extension line of the plurality of edges included in the patterns that constitute the layout, it may be determined that the L/S patterns are the L/S patterns extending lengthwise in the first lateral direction (X direction) or the second lateral direction (Y direction). For example, when an angle between an extension direction of a plurality of edges included in the L/S patterns P1 shown in FIG. 3A and an extension direction of a gauge line GL1 is 90 degrees, it may be determined that the L/S patterns P1 shown in FIG. 3A are L/S patterns extending lengthwise in the second lateral direction (Y direction).

When it is determined in process P202 that the layout does not include the L/S patterns extending lengthwise in the first lateral direction (X direction) or the second lateral direction (Y direction), the method may proceed to process P208. When it is determined in process P202 that, in the layout, L/S patterns exist in the search region that pass through the search region and extend lengthwise in the first lateral direction (X direction) or the second lateral direction (Y direction), the method may proceed to process P203.

In process P203, a length of the edges included in the L/S patterns may be limited to a length inside the search region, which is a portion of the layout.

For example, in the layout shown in FIGS. 3A to 3C, a range of the L/S patterns P1 may be limited to the inside of the search region SR1, and a length of each of the plurality of edges included in the L/S patterns P1 may be limited to the inside of the search region SR1 such that an end of each of the plurality of edges meets a boundary of the search region SR1. Thus, each of the plurality of edges included in the L/S patterns P1 may be set to have a length that extends only inside the search region SR1. For example, the length of an edge included in the L/S patterns P1 may be set to be equal to a length from one edge of the search region SR1 to an opposite edge of the search region SR1.

In process P204, in an interest region that is a portion of the search region, hash codes for information about the edges included in the L/S patterns and information about neighbor edges of each of the edges may be generated.

The hash codes may include hash codes for length information and direction information about each of edges included in the L/S patterns in an interest region that is a partial region selected in the search region, hash codes for length information and direction information about each of neighbor edges included in a neighbor region of each of the edges included in the L/S patterns, and hash codes for distance information between the edges included in the L/S patterns in the interest region. For example, a neighbor region may be an area surrounding an edge of interest that is used to determine the edge's environment. For example, a neighbor region may be set by a user.

In embodiments, as shown in FIGS. 3B and 8, hash codes for various pieces of information about edges included in the L/S patterns P1 in an interest region IR1, which is a portion of the search region SR1, and hash codes for various pieces of information about neighbor edges included in a neighbor region (e.g., a neighbor region NR1 shown in FIG. 3B) of each of the edges may be generated. For example, the hash codes for the L/S patterns P1 shown in FIG. 3B may include hash codes for length information and direction information about each of the edges included in the L/S patterns P1 in the interest region IR1, which is a portion of the search region SR1, hash codes for length information and direction information about each of neighbor edges included in the neighbor region NR1 of each of the edges included in the L/S patterns P1, and hash codes for distance information between the edges included in the L/S patterns P1 in the interest region IR1.

A hash value may be generated for each edge included in the L/S patterns P1 in the interest region IR1. The hash value may be generated using a hash function that accepts as input the various generated hash codes associated with each edge, such as the length and direction of the edge being considered, lengths and directions of neighboring edges within the neighbor region, and inter-edge distances. The hash function may be selected such that edges in the same environment, which will have the same set of inputs for the hash function, are mapped to the unique hash value. For example, edge PE11 shown in FIGS. 3A to 3C may be mapped to a first hash value, and edge PE12 may be mapped to a second hash value that is different from the first hash value.

In process P205, the hash values for respective pieces of information about the edges of the L/S patterns and the neighbor edges may be compared, and at least one first shortest separation distance Dx and at least one second shortest separation distance Dy may be obtained. The at least one first shortest separation distance Dx may be a shortest distance in the first lateral direction (X direction) between two edges (e.g., that extend in the second lateral direction) having the same hash value, from among the edges and the neighbor edges. The at least one second shortest separation distance Dy may be a shortest distance in the second lateral direction (Y direction) between two edges (e.g., that extend in the first lateral direction) having the same hash value.

When it is determined in process P205 that the at least one first shortest separation distance Dx and the at least one second shortest separation distance Dy do not exist in the search region, it may be determined that there is no repeat unit in the search region of the layout, and a process of analyzing the search region may be terminated.

In embodiments, when it is determined in process P205 that at least one first shortest separation distance Dx exists in the search region, the second shortest separation distance Dy may be set to 0. When it is determined in process P205 that at least one second shortest separation distance Dy exists in the search region, a first shortest separation distance Dx may be set to 0. In process P205, when at least one first shortest separation distance Dx or at least one second shortest separation distance Dy exists in the search region, previously considered edges may be excluded from subsequent consideration, and the method may proceed to process P206.

In process P206, it may be determined whether there are unconsidered edges from among edges of a pattern in the search region. When it is determined that there are no unconsidered edges, the method may proceed to process P312 of FIG. 2B. When it is determined in process P206 that unconsidered edges exist in the search region, the method may proceed to process P207 of FIG. 2A.

In process P207, it may be determined whether there are L/S patterns (inclusively referred to as second L/S patterns) extending in a third lateral direction in the search region. The third lateral direction may be oblique with respect to each of the first lateral direction and the second lateral direction. When it is determined in process P207 that the L/S patterns extending in the third lateral direction do not exist in the search region, the method may proceed to process P209. When it is determined in process P207 that L/S patterns extending in the third lateral direction exist in the search region, the method may proceed to process P208.

In process P208, edges (inclusively referred to as second edges) included in the L/S patterns extending in the third lateral direction in the search region may be segmented into a plurality of segments.

For example, as shown in FIG. 4B, from among four sides defining the search region SR2, which is a rectangular region, a first side BD21 and a second side BD22 that are adjacent to each other may be selected. Thereafter, first cut points CUT1 where first cut lines CL1 extending parallel to the second side BD22 meet edges PE21 and PE22 of L/S patterns P2 may be determined from first contact points CP1 where the first side BD21 meets the edges PE21 and PE22. Also, second cut points CUT2 where second cut lines CL2 extending parallel to the first side BD21 meet the edges PE21 and PE22 may be determined from second contact points CP2 where the second side BD22 meets the edges PE21 and PE22. For example, a point at which the first side BD21 intersects the edge PE22 may be set as a first contact point CP1. Then, a line extending from the first contact point CP1 in the first lateral direction (X direction) may be set as a first cut line CL1. Then, a point at which the first cut line CL1 intersects the edge PE21 may be set as a first cut point CUT1. As another example, a point at which the second side BD22 intersects the edge PE22 may be set as a second contact point CP2. Then, a line extending from the second contact point CP2 in the second lateral direction (Y direction) may be set as a second cut line CL2. Then, a point at which the second cut line CL2 intersects the edge PE22 may be set as a second cut point CUT2. See, e.g., FIG. 4B. Thereafter, by segmenting the edges PE21 and PE22 at each of the first cut points CUT1 and the second cut points CUT2, a plurality of segments SEG may be generated from the edges PE21 and PE22.

In another example, in the search region SR3 of the layout shown in FIG. 5B, a plurality of linear components that constitute each of edges included in L/S patterns P3 on which OPC has been performed may be generated as the plurality of segments SEG.

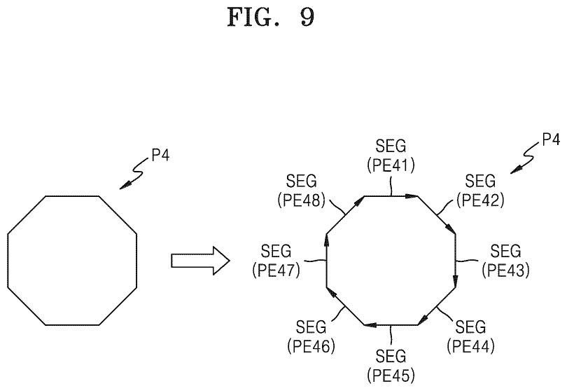

In still another example, in the search region SR4 of the layout shown in FIG. 6B, as shown in FIG. 9, a plurality of linear components that constitute each of edges included in the plurality of island patterns P4 may be generated as the plurality of segments SEG or local edges PE41, PE42, PE43, PE44, PE45, PE46, PE47, and PE48. The local edges PE41, PE42, PE43, PE44, PE45, PE46, PE47, and PE48 may have various lengths and various directions.

In still another example, in the search region SR5 of the layout shown in FIG. 7B, a plurality of linear components that constitute each of edges included in each of a plurality of island patterns P51 and P52 having different shapes may be generated as the plurality of segments SEG.

In process P209, from among the plurality of segments obtained by segmenting the edges PE21 and PE22, segments that are partially outside the search region may be excluded from consideration. To this end, in the search region, only segments of which both endpoints are included in the search region, from among the plurality of segments, may be defined.

For example, in the search region SR2 of the layout shown in FIG. 4B, only segments SEG of which both endpoints are included in the search region SR2, from among the plurality of segments SEG, may be defined as local edges.

In another example, in the search region SR3 of the layout shown in FIG. 5B, only linear components of which both endpoints are included in the search region SR3, from among the plurality of linear components constituting each of the edges included in the L/S patterns P3 on which OPC has been performed, may be defined as segments SEG or local edges.

In still another example, in the search region SR4 of the layout 100 shown in FIG. 6B, as shown in FIG. 9, only linear components of which both endpoints are included in the search region SR4, from the plurality of linear components constituting each of the edges included in the plurality of island patterns P4, may be defined as segments SEG or local edges PE41, PE42, PE43, PE44, PE45, PE46, PE47, and PE48.

In the search region SR5 of the layout shown in FIG. 7B, similar to those described with reference to FIGS. 5B and 6B, only linear components of which both endpoints are included in the search region SR5, from among the plurality of linear components that constitute each of the edges included in each of the plurality of island patterns P51 and P52 having different shapes, may be defined as segments SEG or local edges.

In process P210, in the interest region that is a portion of the search region, hash codes for information about the edges included in the L/S patterns and the neighbor edges of each of the edges may be generated. Herein, the edges may include the segments or the local edges defined in process P209.

The hash codes may include hash codes for length information and direction information about each of edges included in the L/S patterns in the interest region, hash codes for length information and direction information about each of the neighbor edges included in the neighbor region of each of the edges included in the L/S patterns, and hash codes for distance information between the edges included in the L/S patterns in the interest region.

For example, hash codes for the L/S patterns shown in FIG. 4B may include hash codes for length information and direction information about each of segments SEG (inclusively referred to as local edges) of which both endpoints are included in in the search region SR2, from among the plurality of segments SEG included in the L/S patterns P2, in the interest region IR2, which is a portion of the search region SR2, hash codes for length information and direction information about each of neighbor edges included in a neighbor region of each of the local edges included in the L/S patterns P2, and hash codes for distance information between the local edges included in the L/S patterns P2 in the interest region IR2.

In process P211, the hash codes may be compared, and at least one first shortest separation distance Dx and at least one second shortest separation distance Dy may be obtained. The at least one first shortest separation distance Dx may be a shortest distance in the first lateral direction (X direction) between two segments (or local edges) having the same hash code. The at least one second shortest separation distance Dy may be a shortest distance in the second lateral direction (Y direction) between the two segments (or local edges) having the same hash code.

When it is determined in process P211 that the at least one first shortest separation distance Dx and the at least one second shortest separation distance Dy do not exist in the search region, it may be determined that there is no repeat unit in the search region of the layout, and a process of analyzing the search region may be terminated.

When it is determined in process P211 that the at least one first shortest separation distance Dx exists or the at least one second shortest separation distance Dy exists in the search region, the method may proceed to process P312 of FIG. 2B.

In process P312 of FIG. 2B, it may be determined whether the at least one first shortest separation distance Dx or the at least one second shortest separation distance Dy is provided in plurality.

When it is determined in process P312 that the at least one first shortest separation distance Dx is not provided in plurality and the at least one second shortest separation distance Dy is not provided in plurality, the method may proceed to process P314. When it is determined in process P312 that the at least one first shortest separation distance Dx or the at least one second shortest separation distance Dy is provided in plurality, the method may proceed to process P313.

In process P313, when it is determined that the at least one first shortest separation distance Dx includes a plurality of first shortest separation distances Dx and the at least one first shortest separation distance Dx has a value of a non-zero integer, a least common multiple of the plurality of first shortest separation distances Dx may be set as a final first shortest separation distance Dx. Also, when the at least one second shortest separation distance Dy includes a plurality of second shortest separation distances Dy and the at least one second shortest separation distance Dy has a value of a non-zero integer, a least common multiple of the plurality of second shortest separation distances Dy may be set as a final second shortest separation distance Dy.

In embodiments, the least common multiple of the plurality of first shortest separation distances Dx or the least common multiple of the plurality of second shortest separation distances Dy may be obtained by replacing a zero (0) value of at least one of the plurality of first shortest separation distances Dx and the plurality of second shortest separation distances Dy by 1. For example, in a case in which at least one of the plurality of first shortest separation distances Dx is determined to be 0, a value of 1 instead of 0 may be used for purposes of determining the least common multiple of the plurality of first shortest separation distances Dx.

In other embodiments, when the least common multiple of the first shortest separation distance Dx, which is obtained in process P313, is 0, the value of the first shortest separation distance Dx may be replaced by a first basic minimum value. In addition, when the least common multiple of the second shortest separation distance Dy, which is obtained in process P313, is 0, the value of the second shortest separation distance Dy may be replaced by a second basic minimum value. Here, the first basic minimum value may mean a minimum default value in the first lateral direction (X direction), which is required for desired simulation, and the second basic minimum value may mean a minimum default value in the second lateral direction (Y direction), which is required for desired simulation. That is, when the least common multiple of the first shortest separation distance Dx, which is obtained in process P313, is 0, the value of the first shortest separation distance Dx may be determined as a first minimum size in the first lateral direction (X direction), which is required for a desired simulation. When the least common multiple of the second shortest separation distance Dy, which is obtained in process P313, is 0, the value of the second shortest separation distance Dy may be determined as a second minimum value in the second lateral direction (Y direction), which is required for a designed simulation.

In still other embodiments, when it is determined in process P312 that the at least one first shortest separation distance Dx includes a plurality of first shortest separation distances Dx and when at least one of values of the plurality of first shortest separation distances Dx is not an integer in process P313, each of the values of the plurality of first shortest separation distances Dx may be converted into a fractional form, and a value obtained by dividing a least common multiple of respective numerators of the values of the plurality of first shortest separation distances Dx by a greatest common divisor of respective denominators of the values of the plurality of first shortest separation distances Dx may be set as a final first shortest separation distance Dx. In addition, when it is determined in process P312 that the at least one second shortest separation distance Dy includes a plurality of second shortest separation distances Dy and when at least one of values of the plurality of second shortest separation distances Dy is not an integer in process P313, each of the values of the plurality of second shortest separation distances Dy may be converted into a fractional form, and a value obtained by dividing a least common multiple of respective numerators of the values of the plurality of second shortest separation distances Dy by a greatest common divisor of respective denominators of the values of the plurality of second shortest separation distances Dy may be set as a final second shortest separation distance Dy.

When it is determined in process P312 that the at least one first shortest separation distance Dx includes only one first shortest separation distance Dx and the at least one second shortest separation distance Dy includes only one second shortest separation distance Dy, the one first shortest separation distance Dx may be set as the final first shortest separation distance Dx, and the one second shortest separation distance Dy may be set as the final second shortest separation distance Dy. Thereafter, the method may proceed to process P314.

In process P313, when the final first shortest separation distance Dx and the final second shortest separation distance Dy are set, the method may proceed to process P314.

In process P314, it may be determined whether the final first shortest separation distance Dx or the final second shortest separation distance Dy has a value of 0 (hereinafter, a zero (0) value).

When it is determined in process P314 that each of the final first shortest separation distance Dx and the final second shortest separation distance Dy has no zero value, the method may proceed to process P316. When it is determined in process P314 that the final first shortest separation distance Dx or the final second shortest separation distance Dy has the zero value, the method may proceed to process P315.

In process P315, a zero value of at least one of the final first shortest separation distance Dx and the final second shortest separation distance Dy may be replaced by a basic minimum value. Herein, the basic minimum value may refer to a minimum default value required for a desired simulation. For example, when the final first shortest separation distance Dx has the zero value, the zero value of the final first shortest separation distance Dx may be replaced by a first size in the first lateral direction (X direction) in which the desired simulation is possible. Also, when the final second shortest separation distance Dy has the zero value, the zero value of the final second shortest separation distance Dy may be replaced by a second size in the second lateral direction (Y direction) in which the desired simulation is possible.

In process P316, the final first shortest separation distance Dx may be determined as a smallest width of a minimum repeat unit to be obtained, and the final second shortest separation distance Dy may be determined as a smallest height of a minimum repeat unit to be obtained.

In process P316, a repeat unit that is centered on the gauge line and has the smallest width and the smallest height may be determined as the minimum repeat unit.

In the method of finding the minimum repeat unit in the layout, which has been described with reference to FIGS. 1 to 9 according to aspects of the inventive concept, the minimum repeat unit in the layout may be automatically determined based on hash codes obtained from length information and direction information about each of the edges that constitute the layout, and distance information between the edges. In the method of finding the minimum repeat unit in the layout, according to aspects of the inventive concept, minimum repeat unit information may be automatically found in a layout designed to manufacture an IC device, and thus, time and cost for determining the minimum repeat unit information in the layout may be reduced.

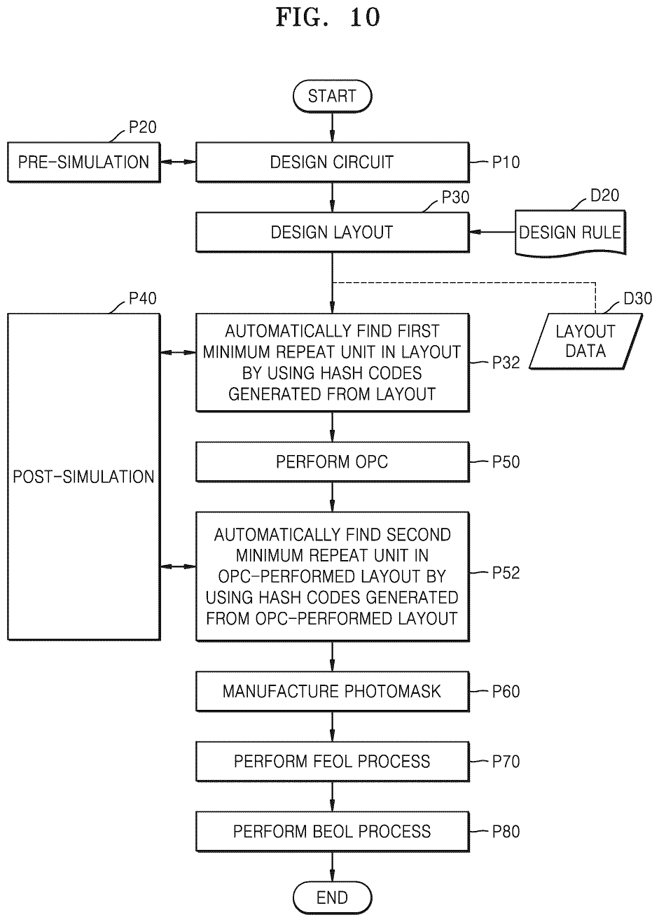

FIG. 10 is a flowchart of a method of manufacturing an IC, according to embodiments.

Referring to FIG. 10, in process P10, circuit design may be performed. For example, various components (e.g., transistors) may be designed to meet the performance of an IC device to be formed. In embodiments, the circuit design may be performed in a circuit design tool that provides a user interface to a designer.

The circuit design according to process P10 may be performed based on a result of a pre-simulation performed in process P20. For example, the pre-simulation may be performed to test the performance of a designed circuit, and a structure of the circuit may be modified based on the pre-simulation result.

In process P30, layout design may be performed. A detailed configuration of the layout design according to process P30 is generally the same as that of the layout design according to P100, which has been described with reference to FIG. 1.

The layout design according to process P30 may be performed with reference to a result of a post-simulation performed in process P40 and/or with reference to a design rule D20. The layout designed in process P30 may be modified based on the result of the post-simulation according to process P40.

When the layout design is completed in process P30, layout data D30 defining the layout may be generated. The layout data D30 may include geometric information on patterns included in an IC device to be formed.

In process P32, a first minimum repeat unit in the layout may be automatically found by using hash codes generated from the layout. The first minimum repeat unit may be automatically found by using the method of finding the minimum repeat unit in the layout, according to the embodiments, which has been described with reference to FIGS. 1 to 9. In process P40, the post-simulation may be performed by using the first minimum repeat unit found in process P32.

In process P50, OPC (e.g., a correction process) may be performed on the layout, and thus, a layout on which OPC has been performed (hereinafter, an OPC-performed layout or a corrected layout) may be designed. OPC may collectively refer to tasks of forming patterns of a desired shape by correcting distortion phenomena, such as refraction caused by the characteristics of light, in a photolithography process performed during the manufacture of an IC device.

In process P52, a second minimum repeat unit of the OPC-performed layout may be automatically found by using hash codes generated from the OPC-performed layout. The second minimum repeat unit may be automatically found by using the method of finding the minimum repeat unit in the layout, according to the embodiments, which has been described with reference to FIGS. 1 to 9. In process P40, post-simulation may be performed by using the second minimum repeat unit found in process P52.

OPC may be applied to the layout data D30, which is a resultant structure of the layout designed in process P30. A final OPC-performed layout may be determined based on the result of performing the post-simulation in process P40 by using the second minimum repeat unit found in process P52. Thereafter, a pattern on a photomask that is manufactured in subsequent process P60 may be determined based on the final OPC-performed layout.

In process P60, the photomask may be manufactured. For example, by applying OPC to the layout data D30, patterns on a photomask required to form a plurality of patterns may be defined, and at least one photomask for forming respective patterns of a plurality of layers may be manufactured.

In process P70, a front-end-of-line (FEOL) process of manufacturing an IC device may be performed.

In the FEOL process, individual devices may be formed on a substrate. The individual devices may include a transistor, a capacitor, and a resistor, without being limited thereto. The FEOL process may include a process of planarizing structures on the substrate, a cleaning process, an etching process, a deposition process, an ion implantation process, a process of forming a conductive film, and a process of forming an insulating film.

In process P80, a back-end-of-line (BEOL) process may be performed.

The BEOL process may include processes of electrically connecting the individual devices formed in process P70 to each other. The BEOL process may include a process of forming a plurality of conductive films, a process of forming a plurality of conductive via contacts, a silicidation process, a plating process, a process of depositing an insulating film, and a process of forming a passivation film. The resultant structure on which the BEOL process is performed according to process P80 may be packaged and used as components for various applications.

In a conventional method of manufacturing an IC device, a user must provide periodicity information of a layout used in the manufacturing process. On the other hand, in the method of manufacturing an IC device, according to aspects of the inventive concept, a minimum repeat unit may be automatically found from a layout by using the above-described method of finding the minimum repeat unit in the layout, according to aspects of the inventive concept, and the layout may be simulated by using the minimum repeat unit that is automatically found. Therefore, in the method of manufacturing an IC device, according to aspects of the inventive concept, simulations and verifications may be efficiently performed on the layout, and thus, a turn-around time (TAT) may be significantly reduced, and the reliability of the IC device may improve.

While the inventive concept has been particularly shown and described with reference to embodiments thereof, it will be understood that various changes in form and details may be made therein without departing from the spirit and scope of the inventive concept.

What is claimed is:

1. A method of manufacturing an integrated circuit device using a layout,
wherein the layout comprises patterns having edges, and
the method comprising:
determining, using a processor, whether periodicity exists in a search region of the layout from values of a first shortest separation distance in a first lateral direction and values of a second shortest separation distance in a second lateral direction between the edges judged to be in the same environment, based on hash codes obtained from length information and direction information about each of the edges in the search region and distance information between the edges, wherein the search region is a selected partial region of the layout centered on a gauge line in the layout, and the second lateral direction is perpendicular to the first lateral direction;
determining, using the processor, a minimum repeat unit of the layout, wherein the determining of the minimum repeat unit comprises determining, as the minimum repeat unit, a unit region of the layout centered on the gauge line and having a smallest width corresponding to a first least common multiple of the values of the first shortest separation distance and a smallest height corresponding to a second least common multiple of the values of the second shortest separation distance; and
forming a corrected layout by performing, using the processor, a correction process on the layout based on the determined minimum repeat unit of the layout; and
forming the integrated circuit device using the corrected layout.

2. The method of claim 1, wherein the determining of the minimum repeat unit comprises:
determining, as the smallest width, a first minimum value at which a desired simulation is possible, when the first least common multiple is 0; and
determining, as the smallest height, a second minimum value at which the desired simulation is possible, when the second least common multiple is 0.

3. The method of claim 1, wherein at least one of the values of the first shortest separation distance is not an integer and at least one of the values of the second shortest separation distance is not an integer, and
wherein the determining of the minimum repeat unit comprises:
converting each of the values of the first shortest separation distance into a fractional form including a first numerator and a first denominator and determining, as the smallest width, a value obtained by dividing a least common multiple of respective first numerators of the values of the first shortest separation distance by a greatest common divisor of respective first denominators of the values of the first shortest separation distance; and
converting each of the values of the second shortest separation distance into a fractional form including a second numerator and a second denominator and determining, as the smallest height, a value obtained by dividing a least common multiple of respective second numerators of the values of the second shortest separation distance by a greatest common divisor of respective second denominators of the values of the second shortest separation distance.

4. The method of claim 1, wherein the layout comprises line-and-space patterns having first edges in an interest region, the first edges passing through the search region and extending in at least one of the first lateral direction and the second lateral direction,
wherein the interest region is a partial region selected from the search region, and
wherein the determining of whether the periodicity exists in the search region comprises:
generating a hash value for each of the first edges, the hash value being based on hash codes for length information and direction information about each of the first edges, hash codes for length information and direction information about each of neighbor edges included in a neighbor region of each of the first edges, and hash codes for distance information between the first edges in the interest region; and
obtaining at least one first shortest separation distance and at least one second shortest separation distance, the at least one first shortest separation distance being a shortest distance in the first lateral direction between two first edges having the same hash value, from among the first edges, and the at least one second shortest separation distance being a shortest distance in the second lateral direction between two first edges having the same hash value, from among the first edges.

5. The method of claim 4, wherein the at least one first shortest separation distance is a plurality of first shortest separation distances,
wherein the at least one second shortest separation distance is a plurality of second shortest separation distances,
wherein the value of each of the plurality of first shortest separation distances and each of the plurality of second shortest separation distances is an integer,
wherein a value of at least one of the plurality of first shortest separation distances and the plurality of second shortest separation distances is not 0,
wherein there are no other patterns except the line-and-space patterns comprising the first edges in the search region, and
wherein the determining of the minimum repeat unit comprises determining a least common multiple of the plurality of first shortest separation distances as the smallest width of the minimum repeat unit and determining a least common multiple of the plurality of second shortest separation distances as the smallest height of the minimum repeat unit.

6. The method of claim 4, wherein the at least one first shortest separation distance comprises only one first shortest separation distance and is an integer,
wherein the at least one second shortest separation distance comprises only one second shortest separation distance and is an integer,
wherein a value of at least one of the first shortest separation distance and the second shortest separation distance is not 0,
wherein there are no other patterns except the line-and-space patterns comprising the first edges in the search region,
wherein the determining of the minimum repeat unit comprises determining the first shortest separation distance as the smallest width of the minimum repeat unit and determining the second shortest separation distance as the smallest height of the minimum repeat unit.

7. The method of claim 4, wherein the determining of the minimum repeat unit comprises:
replacing a zero (0) value of the at least one first shortest separation distance with a first non-zero value in the first lateral direction; and
replacing a zero value of the at least one second shortest separation distance with a second non-zero value in the second lateral direction.

8. The method of claim 1, wherein the layout comprises line-and-space patterns having second edges in an interest region, the second edges passing through the search region and extending in a third lateral direction that is oblique to each of the first lateral direction and the second lateral direction,
wherein the interest region is a partial region selected from the search region,
wherein the determining of whether the periodicity exists in the search region comprises:
segmenting the second edges into a plurality of segments in the search region;
defining, as local edges, segments of the plurality of segments of which both endpoints are included in the search region;
generating a hash value for each of the local edges, the hash value being based on hash codes for length information and direction information about each of the local edges, hash codes for length information and direction information about each of neighbor edges included in a neighbor region of each of the local edges, and hash codes for distance information between the local edges in the interest region; and
obtaining at least one first shortest separation distance and at least one second shortest separation distance, the at least one first shortest separation distance being a shortest distance in the first lateral direction between two local edges having the same hash value, from among the local edges, and the at least one second shortest separation distance being a shortest distance in the second lateral direction between two local edges having the same hash value, from among the local edges.

9. The method of claim 8, wherein the search region comprises a rectangular region,
wherein the segmenting of the second edges into the plurality of segments in the search region comprises:
selecting a first side and a second side, from among four sides defining the search region, the first side and the second side being adjacent to each other;
determining first contact points where the second edges meet the first side;
determining first cut lines extending parallel to the second side from the first contact points;
determining first cut points where the first cut lines meet the second edges;
determining second contact points where the second side meets the second edges;
determining second cut lines extending parallel to the first side from the second contact points;
determining second cut points where the second cut lines meet the second edges; and
generating the plurality of segments segmented from the second edges by segmenting the second edges at each of the first cut points and the second cut points.

10. The method of claim 8, wherein the at least one first shortest separation distance is a plurality of first shortest separation distances,
wherein the at least one second shortest separation distance is a plurality of second shortest separation distances,
wherein the value of each of the plurality of first shortest separation distances and each of the plurality of second shortest separation distances is an integer,
wherein the determining of the minimum repeat unit comprises determining a least common multiple of the plurality of first shortest separation distances as the smallest width of the minimum repeat unit and determining a least common multiple of the plurality of second shortest separation distances as the smallest height of the minimum repeat unit.

11. The method of claim 8, wherein the at least one first shortest separation distance comprises only one first shortest separation distance and is not 0,
wherein the at least one second shortest separation distance comprises only one second shortest separation distance and is not 0,
wherein the determining of the minimum repeat unit comprises determining the first shortest separation distance as the smallest width of the minimum repeat unit and determining the second shortest separation distance as the smallest height of the minimum repeat unit.

12. The method of claim 8, wherein the determining of the minimum repeat unit comprises:
replacing a zero (0) value of the at least one first shortest separation distance with a first non-zero value in the first lateral direction; and
replacing a zero value of the at least one second shortest separation distance by a second non-zero value in the second lateral direction.

13. The method of claim 1, wherein the layout comprises a plurality of island patterns in the search region, each of the plurality of island patterns having third edges in an interest region,
wherein the interest region is a partial region selected from the search region, and
wherein the determining of whether the periodicity exists in the search region comprises:
generating a hash value for each of the third edges, the hash value being based on hash codes for length information and direction information about each of the third edges, hash codes for length information and direction information about each of other edges included in a neighbor region of each of the third edges, and hash codes for distance information between the third edges in the interest region; and
obtaining at least one first shortest separation distance and at least one second shortest separation distance, the at least one first shortest separation distance being a shortest distance in the first lateral direction between two third edges having the same hash value, from among the third edges, and the at least one second shortest separation distance being a shortest distance in the second lateral direction between two third edges having the same hash value, from among the third edges.

14. The method of claim 13, wherein the at least one first shortest separation distance is a plurality of first shortest separation distances,
wherein the at least one second shortest separation distance is a plurality of second shortest separation distances,
wherein the value of each of the plurality of first shortest separation distances and each of the plurality of second shortest separation distances is an integer,
wherein a value of at least one of the plurality of first shortest separation distances and the plurality of second shortest separation distance is not 0, and
wherein the determining of the minimum repeat unit comprises determining a least common multiple of the plurality of first shortest separation distances as the smallest width of the minimum repeat unit and determining a least common multiple of the plurality of second shortest separation distances as the smallest height of the minimum repeat unit.

15. The method of claim 13, wherein the at least one first shortest separation distance comprises only one first shortest separation distance and is an integer,
wherein the at least one second shortest separation distance comprises only one second shortest separation distance and is an integer,
wherein a value of at least one of the first shortest separation distance and the second shortest separation distance is not 0,
wherein the determining of the minimum repeat unit comprises determining the first shortest separation distance as the smallest width of the minimum repeat unit and determining the second shortest separation distance as the smallest height of the minimum repeat unit.

16. The method of claim 13, wherein the determining of the minimum repeat unit further comprises:
replacing a zero (0) value of the at least one first shortest separation with a first non-zero value in the first lateral direction; and
replacing a zero value of the at least one second shortest separation distance with a second non-zero value in the second lateral direction.

17. A method of manufacturing an integrated circuit device using a layout,
wherein the layout comprises patterns having edges, and
the method comprising:
determining, using a processor, a condition of the patterns in a search region of the layout as one of a first condition, a second condition, and a third condition,
wherein in the first condition, the patterns in the search region are first line-and-space patterns extending in any one of a first lateral direction and a second lateral direction,
wherein in the second condition, the patterns in the search region are second line-and-space patterns extending in a third lateral direction, and
wherein in the third condition, the patterns in the search region are a plurality of island patterns;
generating, using the processor, hash codes for length information and direction information about each of the edges, hash codes for length information and direction information about each of neighbor edges included in a neighbor region of each of the edges, and hash codes for distance information between the edges;
determining, using the processor, whether periodicity of the layout exists in the search region from values of a first shortest separation distance in the first lateral direction and values of a second shortest separation distance in the second lateral direction between the edges judged to be in the same environment, based on the hash codes, wherein the search region is a selected partial region centered on a gauge line in the layout, the second lateral direction is perpendicular to the first lateral direction, and the third lateral direction is oblique with respect to each of the first lateral direction and the second lateral direction;
determining, using the processor, the minimum repeat unit of the layout, wherein the determining of the minimum repeat unit comprises determining, as the minimum repeat unit, a unit region of the layout centered on the gauge line and having a smallest width corresponding to a first least common multiple of the values of the first shortest separation distance and a smallest height corresponding to a second least common multiple of the values of the second shortest separation distance; and
forming a corrected layout by performing, using the processor, a correction process on the layout based on the determined minimum repeat unit of the layout; and
forming the integrated circuit device using the corrected layout.

18. The method of claim 17,
wherein, when the condition of the patterns that constitute the layout is the first condition:
the layout comprises line-and-space patterns having first edges in an interest region, the first edges passing through the search region and extending in at least one of the first lateral direction and the second lateral direction;
the interest region is a partial region selected from the search region; and
the determining of whether the periodicity of the layout exists in the search region comprises generating a hash value for each of the first edges, the hash value being based on hash codes for length information and direction information about each of the first edges, hash codes for length information and direction information about each of neighbor edges included in a neighbor region of each of the first edges, and hash codes for distance information between the first edges in the interest region, wherein the interest region is a partial region selected in the search region,
wherein, when the condition of the patterns that constitute the layout is the second condition:
the layout comprises line-and-space patterns having second edges in the interest region, the second edges passing through the search region and extending in a third lateral direction that is oblique to each of the first lateral direction and the second lateral direction; and
the determining of whether the periodicity of the layout exists in the search region comprises segmenting the second edges into a plurality of segments in the search region;
determining whether both endpoints of each of the plurality of segments are included in the search region and defining, as local edges, segments of the plurality of segments of which the both endpoints are included in the search region; and generating a hash value for each of the local edges, the hash value being based on hash codes for length information and direction information about each of the local edges, hash codes for length information and direction information about each of neighbor edges included in a neighbor region of the local edges, and hash codes for distance information between the local edges in the interest region,
wherein, when the condition of the patterns that constitute the layout is the third condition:
the layout comprises a plurality of island patterns in the search region, each of the plurality of island patterns having third edges in the interest region; and
the determining of whether the periodicity of the layout exists in the search region comprises generating a hash value for each of the third edges, the has value being based on hash codes for length information and direction information about each of the third edges, hash codes for length information and direction information about each of other third edges included in a neighbor region of each of the third edges, and hash codes for distance information between the third edges in the interest region,
wherein, under each of the first to third conditions, the determining of the minimum repeat unit comprises:
obtaining at least one first shortest separation distance and at least one second shortest separation distance, the at least one first shortest separation distance being a shortest distance in the first lateral direction between edges having the same hash value, and the at least one second shortest separation distance being a shortest distance in the second lateral direction between the edges having the same hash value; and
determining the minimum repeat unit, based on the at least one first shortest separation distance and the at least one second shortest separation distance.

19. A method of manufacturing an integrated circuit device, the method comprising:
designing, using a processor, a layout, the layout comprising patterns having edges;
automatically finding, using the processor, a first minimum repeat unit in the layout; and
simulating, using the processor, the layout by using the first minimum repeat unit,
wherein the automatically finding of the first minimum repeat unit in the layout comprises:
determining whether periodicity exists in a search region of the layout from values of a first shortest separation distance in a first lateral direction and values of a second shortest separation distance in a second lateral direction between the edges judged to be in the same environment, based on hash codes for length information and direction information about each of the edges in a search region and distance information between the edges, wherein the search region is a selected partial region of the layout centered on a gauge line in the layout, and the second lateral direction is perpendicular to the first lateral direction; and
determining, as the minimum repeat unit of the layout, a unit region of the layout centered on the gauge line and having a smallest width corresponding to a first least common multiple of the values of the first shortest separation distance and a smallest height corresponding to a second least common multiple of the values of the second shortest separation distance.

20. The method of claim 19, further comprising:
after the designing of the layout, performing optical proximity correction (OPC) on the layout and designing a corrected layout on which OPC has been performed; and
automatically finding a second minimum repeat unit in the corrected layout on which OPC has been performed, by using new hash codes generated from the corrected layout on which OPC has been performed.
